(19) United States
(12) Patent Application Publication
(10) Pub. No.: US 2013/0021297 A1
(43) Pub. Date: Jan. 24, 2013

(54) TOUCH PANEL

(71) Applicant: Michael Lee, Taichung City (TW)

(72) Inventor: Michael Lee, Taichung City (TW)

(21) Appl. No.: 13/241,920

(22) Filed: Sep. 23, 2011

(30) Foreign Application Priority Data
Jul. 18, 2011 (TW) 100125316

(51) Int. Cl. G06F 3/042

(52) U.S. Cl. 345/175

(57) ABSTRACT

A touch panel includes a transparent substrate defining a touch surface and a non-touch surface, and a light guide plate arranged at the non-touch surface of the transparent substrate. The light guide plate defines a light output surface facing toward the non-touch surface of the transparent substrate, a bottom surface opposite to the light output surface, a light incident surface connected between the light output surface and the bottom surface, and a plurality of spaced refraction zones. Based on the aforesaid arrangement, the touch panel produces a uniform brightness distribution across the screen.

### BACKGROUND OF THE INVENTION

1. Field of the Invention

The present invention relates to touch panel technology and more particularly, to a touch panel that gives off uniform light over its entire surface.

2. Description of the Related Art

In recent years, touch panel has been intensively used in a variety of electronic products, such as PDA, intelligent mobile phone and tablet PC. A user can zoom in, zoom out or rotate the screen display, or play multimedia files simply by means of touching the display screen of the touch panel. Subject to the use of a touch panel, a touch screen mobile phone does not require a conventional mechanical numeric keypad, and therefore the size of the display screen of the touch screen mobile phone can be maximized, facilitating web browsing.

FIG. 1 illustrates a mobile phone touch panel 10 commonly used at the present time. This design of mobile phone touch panel 10 comprises a transparent substrate 11 and a light-emitting unit 13. The transparent substrate 11 comprises opposing touch surface 111 and non-touch surface 113. The touch surface 111 is divided into a main touch zone 115 and a sub touch zone 117. The light-emitting unit 13 comprises a flexible circuit board 131 mounted at the non-touch surface 113, and a plurality of LED light sources 133 respectively installed in the flexible circuit board 131 corresponding to respective key patterns P visible through the sub touch zone 117. The main touch zone 115 is adapted for the control of file execution or screen display enlargement. The sub touch zone 117 provides a limited number of function keys, such as switch buttons. The key patterns P are printed on the non-touch surface 113 opposite to the sub touch zone 117 corresponding to the function keys in the sub touch zone 117, facilitating the user to operate the sub touch zone 117.

For enabling the user to operate the function keys in the sub touch zone 117 in the dark, every key pattern P must be equipped with one respective LED light source 133. This light source arrangement wastes energy and is not economic. Further, because only the key patterns P can give off light, the brightness of the entire sub touch zone 117 is not uniform.

### SUMMARY OF THE INVENTION

The present invention has been accomplished under the circumstances in view. It is the main object of the present invention to provide a touch panel, which gives off uniform light over its entire surface.

To achieve this and other objects of the present invention, a touch panel comprises a transparent substrate, and a light guide plate arranged at the transparent substrate. The transparent substrate defines a touch surface, and a non-touch surface opposite to the touch surface. The light guide plate defines a light output surface facing toward the non-touch surface of the transparent substrate, a bottom surface opposite to the light output surface, a light incident surface connected between the light output surface and the bottom surface, and a plurality of spaced refraction zones. Subject to the arrangement of the spaced refraction zones, the touch panel produces a uniform brightness distribution across the screen.

The touch panel further comprises a flexible circuit board mounted at the bottom surface of the light guide plate, and a point light source installed in the flexible circuit board and adapted for emitting light onto the light incident surface of the light guide plate. Thus, the light emitted by the point light source can enter the light guide plate and can then be reflected or diffused by the refraction zones and finally sent out of the light output surface of the light guide plate in a uniform manner.

Further, the light guide plate of the touch panel further comprises a light-transmission plate defining a first surface corresponding to the light output surface and a second surface corresponding to the bottom surface, a first adhesive layer set between the first surface of the light guide plate and the non-touch surface of the transparent substrate, and a second adhesive layer set between the second surface of the light guide plate and the flexible circuit board. Thus, the light guide plate is positively set between the non-touch surface of the transparent substrate and the flexible circuit board.

Further, the refraction zones of the light guide plate can be arranged at one or both of the first surface and second surface of the light-transmission plate.

In one embodiment of the present invention, the light guide plate further comprises a reflective layer laminated on the second adhesive layer, and a third adhesive layer set between the reflective layer and the flexible circuit board. Thus, the reflective layer reflects the light coming out of the second surface of the light-transmission plate backwardly onto the inside of the light-transmission plate, raising the light utilization rate.

In the preferred embodiment of the present invention, the light guide plate further comprises a diffusion layer laminated on the first adhesive layer, and a fourth adhesive layer set between the diffusion layer and the non-touch surface of the transparent substrate. Thus, the diffusion layer diffuses the light coming out of the light output surface of the light guide plate, enhancing uniform distribution of light and softening the light.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an exploded view of a touch panel according to the prior art.

FIG. 2 is an exploded view of a touch panel in accordance with the present invention.

FIG. 3 is an oblique elevation, in an enlarged scale, of the light guide plate shown in FIG. 2.

FIG. 4 is a top view of the touch panel in accordance with the present invention, illustrating the light guide plate sandwiched between the transparent substrate and the flexible circuit board.

FIG. 5 is a schematic drawing illustrating the configuration of the laminated structure of the light guide plate in accordance with the present invention.

FIG. 6 is similar to FIG. 5, illustrating an alternate form of the laminated structure of the light guide plate.

FIG. 7 is similar to FIG. 5, illustrating another alternate form of the laminated structure of the light guide plate.

FIG. 8 is an elevational view of the present invention, illustrating an alternate form of the refraction zone of the light guide plate.

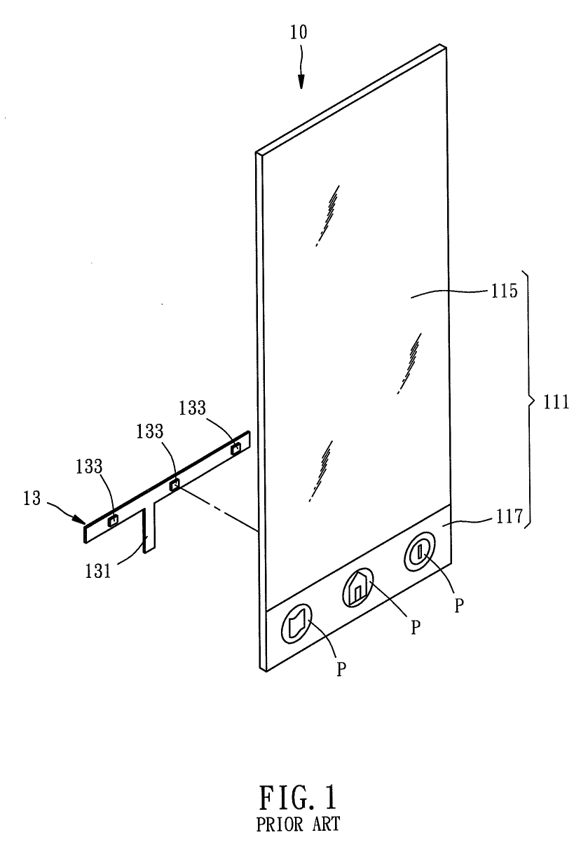

### DETAILED DESCRIPTION OF THE INVENTION

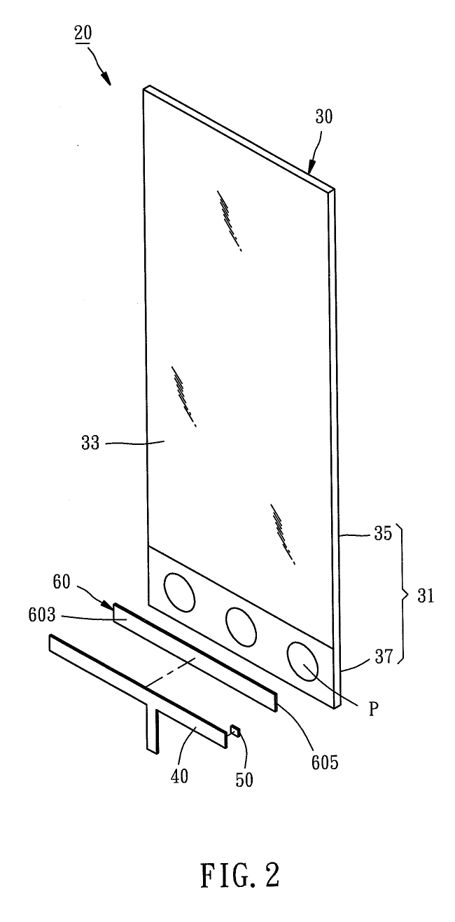

Referring to FIGS. 2-5, a touch panel 20 in accordance with the present invention is shown comprising a transparent substrate 30, a point light source 40, a flexible circuit board 50 and a light guide plate 60.

The transparent substrate 30 can be made of, but not limited to, glass, polycarbonate (PC), polymethyl methacrylate (PMMA), or cycloolefin copolymer (COC). The transparent substrate 30 comprises a touch surface 31, and a non-touch surface 33 opposite to the touch surface 31. The touch surface 31 is divided into a main touch zone 35 and a sub touch zone 37 at the border area of the main touch zone 35. Further, the non-touch surface 33 has a plurality of key patterns P printed or coated thereon at selected locations corresponding to the sub touch zone 37.

The flexible circuit board 40 has a circuit layout arranged thereon. The point light source 50 can be, for example, but not limited to, a LED (light-emitting diode). The flexible circuit board 40 is electrically coupled with the point light source (LED) 50, providing the point light source (LED) 50 with the necessary working voltage.

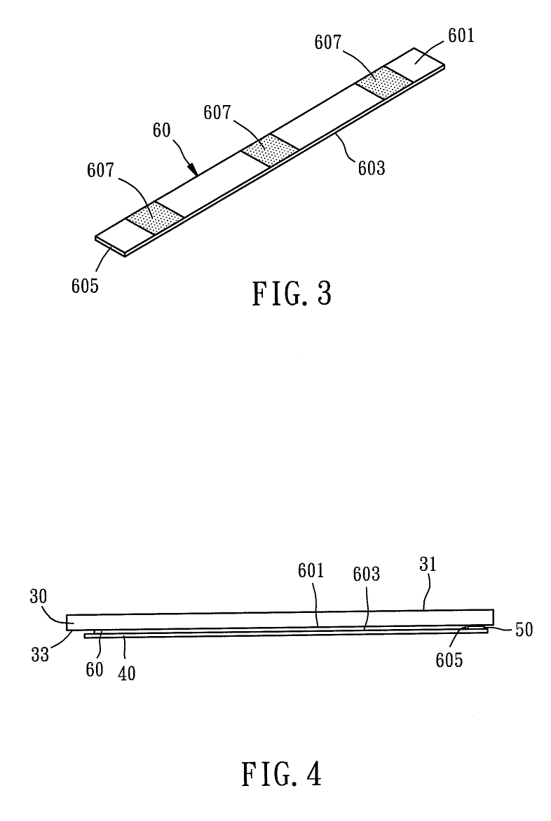

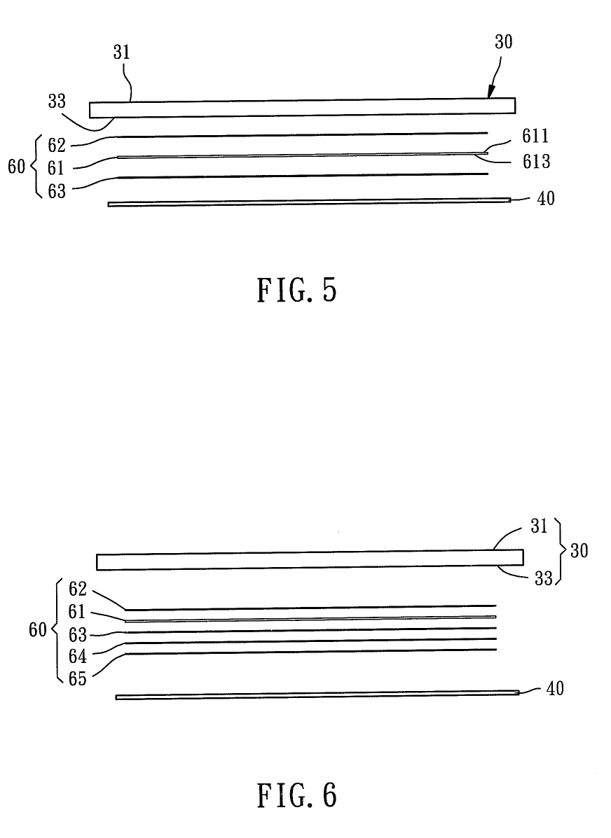

The light guide plate 60, as shown in FIGS. 2 and 3, is a rectangular strip, defining a light output surface 601, a bottom surface 603 opposite to the light output surface 601, a side surface, namely, the light incident surface 605 vertically connected between the light output surface 601 and the bottom surface 603, and a plurality of spaced refraction zones 607. As illustrated in FIG. 5, the light guide plate 60 is formed of a light-transmission plate 61, a first adhesive layer 62 and a second adhesive layer 63. The light-transmission plate 61 is made of, but not limited to, polycarbonate (PC), polymethyl methacrylate (PMMA) or polyethylene terephthalate (PET). The first adhesive layer 62 and the second adhesive layer 63 are preferably selected from solid or liquefied optical clear adhesive (OCA), for example, acrylic adhesive. Further, the light-transmission plate 61 has a first surface 611 facing toward the light output surface 601, and a second surface 613 facing toward the bottom surface 603. Further, the refraction zones 607 can be arranged at the first surface 611 or second surface 613 of the light-transmission plate 61. In this embodiment, the refraction zones 607 is arranged at the first surface 611 of the light-transmission plate 61, having a dot pattern (as shown in FIG. 3). During installation, as shown in FIGS. 4 and 5, attach the light output surface 601 of the light-transmission plate 61 to the non-touch zone 33 of the transparent substrate 30 corresponding to the sub touch zone 37, and arrange the flexible circuit board 40 at the bottom surface 603 of the light guide plate 60 and the point light source 50 at a suitable location for emitting light toward the light incident surface 605 of the light guide plate 60. Thus, the first adhesive layer 62 that is laminated on the first surface 611 of the light-transmission plate 61 is kept between the first surface 611 of the light-transmission plate 61 and the non-touch surface 33 of the non-touch transparent substrate 30, and the second adhesive layer 63 that is laminated on the second surface 613 of the light-transmission plate 61 is kept between the second surface 613 of the light-transmission plate 61 and the flexible circuit board 40.

Thus, the light emitted by the point light source 50 will fall upon the light incident surface 605 into the inside of the light guide plate 60, and will then be reflected onto or dispersed over the entire light output surface 601 of the light guide plate 60 by the dots of the refraction zones 607, uniformly brightening the entire surface of the sub touch zone 37 of the transparent substrate 30.

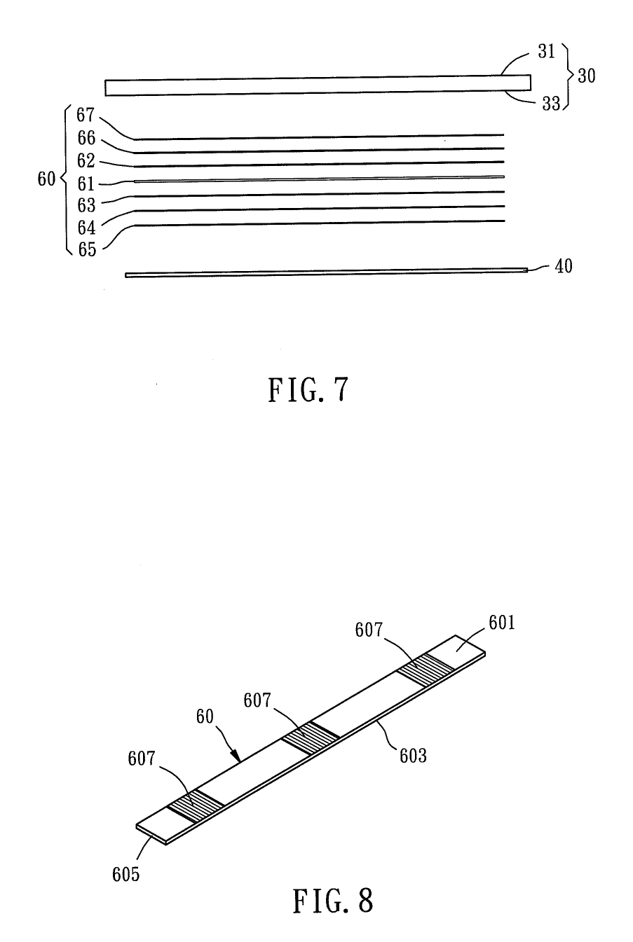

Actually, the light guide plate 60 used in the touch panel 20 can be variously embodied. FIGS. 6 and 7 show two alternate forms of the light guide plate 60. According to the embodiment shown in FIG. 6, the light guide plate 60 further comprises a reflective layer 64 and a third adhesive layer 65. The reflective layer 64 is laminated on the second adhesive layer 63. The third adhesive layer 65 is laminated on the reflective layer 64. Thus, the third adhesive layer 65 is kept between the reflective layer 64 and the flexible circuit board 40. During operation, the reflective layer 64 reflects the light that passed out of the second surface 613 of the light-transmission plate 61 backwardly onto the inside of the light-transmission plate 61, raising light utilization rate. According to the embodiment shown in FIG. 7, the light guide plate 60 further comprises a diffusion layer 66 and a fourth adhesive layer 67. The diffusion layer 66 is laminated on the first adhesive layer 62. The fourth adhesive layer 67 is laminated on the diffusion layer 66. Thus, the fourth adhesive layer 67 is kept between the diffusion layer 66 and the non-touch surface 33 of the transparent substrate 30. During operation, the diffusion layer 66 diffuses the light that passed out of the light output surface 601 of the light guide plate 60, enhancing uniform distribution of light and softening the light. Further, the aforesaid third adhesive layer 65 and fourth adhesive layer 67 are preferably selected from the same solid or liquefied optical clear adhesive (OCA) as stated above.

Further, it is to be understood that the aforesaid reflective layer 64 or diffusion layer 66 is optional. Both the reflective layer 64 and the diffusion layer 66 can exist concomitantly or individually. Further, during fabrication, the configuration of the refraction zones 607 of the light guide plate 60 is not limited to the aforesaid dot pattern. For example, the refraction zones 607 of the light guide plate 60 can be configured to provide a stripe pattern (see FIG. 8), etch pattern, or any of a variety of other designs.

In conclusion, the touch panel of the present invention has built therein a light guide plate having spaced refraction zones, therefore, the invention simply needs to use one single LED to produce a uniform brightness distribution across the screen. When compared with conventional touch panels, the invention saves energy consumption and enables the touch panel to give off uniform light over the entire surface of its sub touch zone. Further, subject to the arrangement of a reflective layer or diffusion layer, the invention greatly raises the luminous efficiency of the touch panel.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A touch panel, comprising:
a transparent substrate defining a touch surface and a non-touch surface opposite to said touch surface; and
a light guide plate arranged at said non-touch surface of said transparent substrate, said light guide plate comprising a light output surface facing toward said non-touch surface of said transparent substrate, a bottom surface opposite to said light output surface, a light incident surface connected between said light output surface and said bottom surface, and a plurality of spaced refraction zones.

2. The touch panel as claimed in claim 1, further comprising a flexible circuit board mounted at said bottom surface of said light guide plate, and a point light source installed in said flexible circuit board and adapted for emitting light onto said light incident surface of said light guide plate.

3. The touch panel as claimed in claim 2, wherein said light guide plate comprises:
a light-transmission plate defining a first surface corresponding to said light output surface and a second surface corresponding to said bottom surface;
a first adhesive layer set between said first surface of said light guide plate and said non-touch surface of said transparent substrate; and
a second adhesive layer set between said second surface of said light guide plate and said flexible circuit board.

4. The touch panel as claimed in claim 3, wherein said light guide plate further comprises a reflective layer laminated on said second adhesive layer, and a third adhesive layer set between said reflective layer and said flexible circuit board.

5. The touch panel as claimed in claim 4, wherein said light guide plate further comprises a diffusion layer laminated on said first adhesive layer, and a fourth adhesive layer set between said diffusion layer and said non-touch surface of said transparent substrate.

6. The touch panel as claimed in claim 3, wherein said light guide plate further comprises a diffusion layer laminated on said first adhesive layer, and a fourth adhesive layer set between said diffusion layer and said transparent substrate.

7. The touch panel as claimed in claim 3, wherein said refraction zones are disposed in at least one of said first surface and said second surface of said light-transmission plate.

8. The touch panel as claimed in claim 1, wherein said touch surface of said transparent substrate comprises a main touch zone, and a sub touch zone at a border area of said main touch zone; said light guide plate is arranged at said non-touch surface corresponding to said sub touch zone of said touch surface.

9. The touch panel as claimed in claim 1, wherein said refraction zones are configured to provide one of dot pattern, stripe pattern and etch pattern.
